(19) United States
(12) Patent Application Publication
(10) Pub. No.: US 2015/0151680 A1
(43) Pub. Date: Jun. 4, 2015

(54) VIRTUAL ENGINE SOUND SYSTEM FOR VEHICLE AND METHOD FOR CONTROLLING THE SYSTEM

(71) Applicant: HYUNDAI MOTOR COMPANY, SEOUL (KR)

(72) Inventors: Jung Seob Park, Gyeonggi-do (KR); Seung-Chang Park, Seoul (KR)

(21) Appl. No.: 14/319,208

(22) Filed: Jun. 30, 2014

(30) Foreign Application Priority Data
Dec. 2, 2013 (KR) 10-2013-0148752

(51) Int. Cl. B60Q 5/00

(52) U.S. Cl. CPC B60Q 5/008

(57) ABSTRACT

A virtual engine sound system for a vehicle and a method for controlling the system are provided. The method includes detecting data for determining volume of the virtual engine sound and determining whether an output condition of the virtual engine sound is satisfied based on the data. In addition, the method includes determining a sound source to be played back when the output condition of the virtual engine sound is satisfied and determining the volume of the virtual engine sound based on a noise level extraneous to the vehicle. The virtual engine sound that corresponds to the determined volume is then output.

### CROSS-REFERENCE TO RELATED APPLICATION

This application claims priority to and the benefit of Korean Patent Application No. 10-2013-0148752 filed in the Korean Intellectual Property Office on Dec. 2, 2013, the entire contents of which are incorporated herein by reference.

### BACKGROUND

(a) Field of the Invention

The present invention relates to a virtual engine sound system for a vehicle and a method for controlling the system. More particularly, the present invention relates to a virtual engine sound system for controlling a volume of a virtual engine sound based on a noise level surrounding a vehicle and a method for controlling the system.

(b) Description of the Related Art

In general, hybrid vehicles, electric vehicles, and fuel cell vehicles, which are usually called environmentally-friendly vehicles, are driven by a drive motor that generates a torque from electrical energy. When an environmentally-friendly vehicle is driven only by the drive motor, noise generated from the environmentally-friendly vehicle is substantially low such that it may be difficult for pedestrians to perceive approach of the vehicle. As a countermeasure, a virtual engine sound system (VESS) that outputs a virtual engine sound via a speaker to allow pedestrians to perceive the approach of the vehicle has been developed.

However, the conventional virtual engine sound system controls the volume of the virtual engine sound based on a vehicle speed, and thus it may be difficult for pedestrians to perceive the approach of the vehicle when the noise surrounding the vehicle is substantially high (e.g., downtown areas, market areas, or tourist areas). Accordingly, the virtual engine sound needs to be controlled based on the noise level surrounding the vehicle.

The above information disclosed in this section is merely for enhancement of understanding of the background of the invention and therefore it may contain information that does not form the prior art that is already known in this country to a person of ordinary skill in the art.

### SUMMARY

The present invention has been made in an effort to provide a virtual engine sound system for a vehicle and a method for controlling the system having advantages of effectively adjusting the virtual engine sound based on a current position of the vehicle and a noise level in the vicinity of the vehicle.

A method for adjusting a virtual engine sound for a vehicle according to an exemplary embodiment of the present invention may include: detecting data for determining volume of the virtual engine sound; determining whether an output condition of the virtual engine sound is satisfied based on the data; determining a sound source to be played back when the output condition of the virtual engine sound is satisfied; determining the volume of the virtual engine sound based on a noise level extraneous to the vehicle; and outputting the virtual engine sound that corresponds to the determined volume.

The determination of the volume of the virtual engine sound may include: determining the volume of the virtual engine sound as a value greater than or equal to the noise level when the noise level is greater than or equal to a first level; and determining the volume of the virtual engine sound as a value equivalent to the first level when the noise level is less than the first level. The first level may be changed based on a current position of the vehicle. The output condition of the virtual engine sound may be satisfied when the vehicle travels. The sound source to be played back may be determined from among a plurality of sound sources based on a current position of the vehicle. The plurality of sound sources may be updated via a telematics device by wire or wirelessly. The determination of the volume of the virtual engine sound may further include adjusting the determined volume of the virtual engine sound based on at least one of a vehicle speed and an inter-vehicle distance.

The method may further include: determining whether an output termination condition of the virtual engine sound is satisfied; and terminating output of the virtual engine sound when the output termination condition of the virtual engine sound is satisfied, wherein the output termination condition is satisfied when the vehicle is stopped. When the vehicle includes an engine, the output termination condition may be satisfied when the engine is operated.

A virtual engine sound system outputting a virtual engine sound to the outside of a vehicle via a speaker according to an exemplary embodiment of the present invention may include a data detector configured to detect data for determining the volume of the virtual engine sound, and a controller executed by a predetermined program to adjust the speaker based on the data, wherein the predetermined program includes a series of commands for performing a method for adjusting the virtual engine sound, wherein the method may include: detecting the data for determining the volume of the virtual engine sound; determining whether an output condition of the virtual engine sound is satisfied based on the data; determining a sound source to be played back when the output condition of the virtual engine sound is satisfied; determining the volume of the virtual engine sound based on a noise level extraneous to the vehicle; and outputting the virtual engine sound that corresponds to the determined volume.

According to an exemplary embodiment of the present invention, the appropriate sound source may be set based on the current position of the vehicle. The volume of the virtual engine sound may be effectively adjusted to achieve safety of a pedestrian. Since the output condition and the output termination condition of the virtual engine sound may be set, it may be possible to suppress generation of an unnecessary virtual engine sound.

### BRIEF DESCRIPTION OF THE DRAWINGS

FIG. 1 is an exemplary block diagram of a virtual engine sound system according to an exemplary embodiment of the present invention; and

FIG. 2 is an exemplary flowchart of a method for controlling a virtual engine sound according to an exemplary embodiment of the present invention.

### DESCRIPTION OF SYMBOLS

10: Data detector
20: Controller
30: Speaker

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

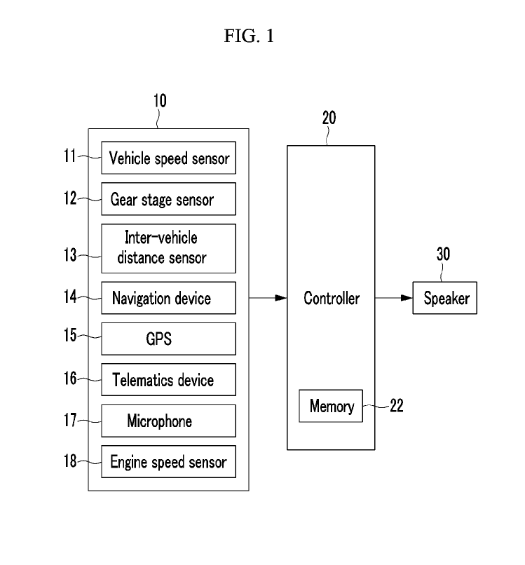

FIG. 1 is an exemplary block diagram of a virtual engine sound system according to an exemplary embodiment of the present invention. A vehicle in which a virtual engine sound system according to an exemplary embodiment of the present invention is mounted may be a hybrid vehicle, an electric vehicle, or a fuel cell vehicle operated by a drive motor. As shown in FIG. 1, a virtual engine sound system according to an exemplary embodiment of the present invention may include a data detector 10, a controller 20, and a speaker 30.

The data detector 10 may be configured to detect data for controlling a virtual engine sound, and the data detected by the data detector 10 may be transmitted to the controller 20. The data detector 10 may include a vehicle speed sensor 11, a gear stage sensor 12, an inter-vehicle distance sensor 13, a navigation device 14, a global positioning system (GPS) 15, a telematics device 16, and a microphone 17.

In particular, the vehicle speed sensor 11 may be configured to detect a vehicle speed, and may be mounted at a wheel of the vehicle. In addition, the vehicle speed may be calculated based on a GPS signal received by the GPS 15. The gear stage sensor 12 may be configured to detect a gear stage currently engaged. The inter-vehicle distance sensor 13 may be configured to detect an inter-vehicle distance between the vehicle and a preceding vehicle. Various sensors such as an ultrasonic wave sensor and an infrared sensor may be used as the inter-vehicle distance sensor 13. The navigation device 14 may be a device configured to inform the driver of a route to a destination. The navigation device 14 may include an input and output portion that inputs or outputs information for guidance of the route, a current position detecting portion that detects information regarding a current position of the vehicle, a memory in which a map data for calculating the route and a data for guiding the route may be stored, and a control portion that searches the route and performs guidance of the route. The GPS 15 may be configured to receive a signal transmitted from a GPS satellite and transmit a corresponding signal to the navigation device 14. The navigation device 14 may be configured to calculate the current position of the vehicle based on the signal. The telematics device 16 may be configured to receive environment information such as road information, traffic information, and weather information from a telematics service center. The telematics device 16 may be configured to receive the map data from the telematics service center by wire or wirelessly. The microphone 17 may be configured to detect a noise level extraneous to the vehicle.

For a hybrid vehicle that includes an engine, the data detector 10 of the virtual engine sound system according to an exemplary embodiment of the present invention may further include an engine speed sensor 18. The engine speed sensor 18 may be configured to detect an engine speed by a rotation speed of a crankshaft that rotates according to an operation of the engine. However, it may be sufficient in an exemplary embodiment of the present invention that the engine speed sensor 18 is configured to provide information regarding the operation of the engine to the controller 20. Therefore, it is to be understood that the engine speed sensor 18 may include any device which may provide the information regarding the operation of the engine to the controller 20 in this specification and the claims.

The controller 20 may be configured to adjust the speaker 30 based on the data detected by the data detector 10. The controller 20 may be implemented with one or more microprocessors executed by a predetermined program. The predetermined program may include a series of commands for performing each step included in a method for controlling the virtual engine sound according to an exemplary embodiment of the present invention described below. The controller 20 may include a memory 22 configured to store at least one sound source, a codec that converts a digital sound source signal to an analog sound source signal, and an amplifier that amplifies the analog sound source signal output from the codec. The codec and the amplifier are obvious and known to a person of ordinary skill in the art, and thus detailed description thereof will be omitted.

A plurality of sound sources may be transmitted from the telematics service center to the telematics device 16 by wire or wirelessly. Accordingly, the plurality of sound sources stored in the memory 22 may be updated. The controller 20 may be configured to output the virtual engine sound via the speaker 30. The speaker 30 may be mounted within an engine compartment.

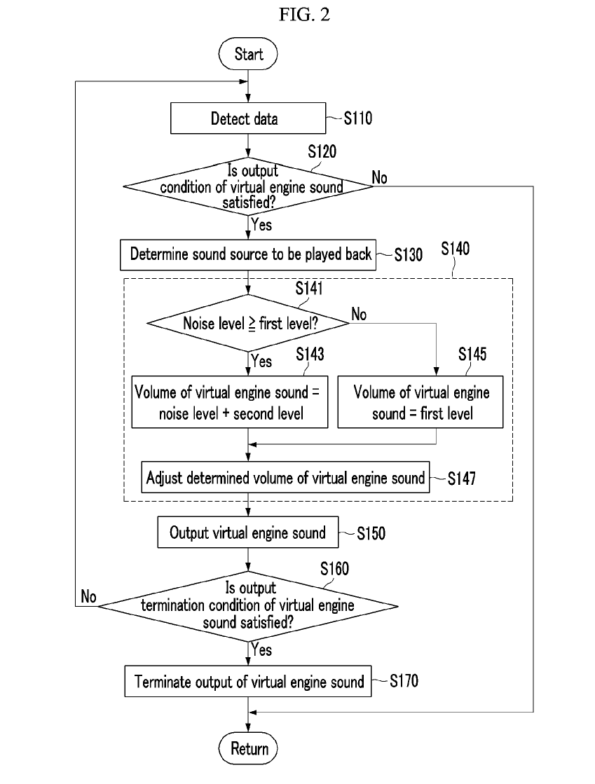

Hereinafter, referring to FIG. 2, the method for controlling the virtual engine sound according to the exemplary embodiment of the present invention will be described in detail. FIG. 2 is an exemplary flowchart of a method for controlling a virtual engine sound according to an exemplary embodiment of the present invention.

As shown in FIG. 2, the method for controlling the virtual engine sound according to an exemplary embodiment of the present invention may include detecting, by a sensor unit (e.g., the data detector 10), the data for controlling the speaker 30 at step S110. The sensor unit may include a vehicle speed sensor, a gear stage sensor, an inter-vehicle distance sensor, a navigation device and a microphone. In particular, the vehicle speed sensor 11 may be configured to detect the vehicle speed, the gear stage sensor 12 may be configured to detect the gear stage currently engaged, the inter-vehicle distance sensor 13 may be configured to detect the inter-vehicle distance, the navigation device 14 may be configured to detect the current position of the vehicle, and the microphone 17 may be configured to detect the noise level extraneous to the vehicle.

When the data detector 10 detects and transmits the data to the controller 20, the controller 20 may be configured to determine whether an output condition of the virtual engine sound is satisfied at step S120. For example, the output condition of the virtual engine sound may be satisfied when the vehicle is traveling. In other words, the controller 20 may be configured to determine that the output condition of the virtual engine sound is satisfied when the gear stage is a driving stage (D-stage) or a reverse driving stage (R-stage), or when the vehicle speed is greater than about 0 km/h. When the output condition of the virtual engine sound is not satisfied at the S120, the controller 20 may terminate the method for controlling the virtual engine sound according to the exemplary embodiment of the present invention. When the output condition of the virtual engine sound is satisfied at the step S120, the controller 20 may be configured to determine a sound source to be played back based on the current position of the vehicle at step S130. In other words, each of the plurality of sound sources stored in the memory 22 may be preset to correspond to a specific area (e.g., a downtown area, a school zone, a market area, a tourist area, or a highway). For example, for a school zone, a sound source that may arouse a student's attention may be preset.

The controller 20 may be configured to determine the volume of the virtual engine sound based on the noise level at step S140. The controller 20 may be configured to compare the noise level with a first level at step S141. The first level may be preset to correspond to the specific area. In other words, the first level may be changed based on the current position of the vehicle. When the noise level is greater than or equal to the first level, the controller 20 may be configured to determine the volume of the virtual engine sound as the value that is greater than or equal to the noise level at step S143. For example, the controller 20 may be configured to determine the volume of the virtual engine sound as a value obtained by adding the noise level and a second level so that the output volume of the virtual engine sound is greater than the noise level. The second level may be arbitrarily set by a person of ordinary skill in the art.

Further, the controller 20 may proceed to step S147. When the noise level is less than the first level at the S141, the controller 20 may be configured to determine the volume of the virtual engine sound as a value that is about equal to the first level at step S145. The controller 20 may be configured to adjust the determined volume of the virtual engine sound based on at least one of the vehicle speed and the inter-vehicle distance at step S147. For example, the controller 20 may be configured to increase the volume of the virtual engine sound as the vehicle speed is increased, and thereby a virtual engine sound similar to a real engine sound may be generated. Further, the controller 20 may be configured to increase the volume of the virtual engine sound as the inter-vehicle distance is decreased, and thereby the driver's attention may be aroused.

The controller 20 may be configured to output the virtual engine sound that corresponds to the determined volume via the speaker 30 at step S150. Additionally, the controller 20 may be configured to determine whether an output termination condition of the virtual engine sound is satisfied at step S160. For example, the output termination condition of the virtual engine sound may be satisfied when the vehicle is stopped. In other words, when the gear stage is a parking stage (P-range) or the vehicle speed is about 0 km/h for a predetermined time period, the controller 20 may be configured to determine that the vehicle is stopped. For the hybrid vehicle that includes the engine, the output termination condition of the virtual engine sound may be satisfied when the engine is operated. When the output termination condition of the virtual engine sound is not satisfied at the step S160, the controller 20 may proceed to the step S110. When the output termination condition of the virtual engine sound is satisfied at the step S160, the controller 20 may be configured to terminate the output of the virtual engine sound at step S170 and terminate the method of controlling the virtual engine sound according to an exemplary embodiment of the present invention.

As described above, according to an exemplary embodiment of the present invention, the appropriate sound source may be set based on the current position of the vehicle. The volume of the virtual engine sound may be effectively adjusted to achieve safety of a pedestrian. Since the output condition and the output termination condition of the virtual engine sound may be set, it may be possible to suppress generation of an unnecessary virtual engine sound.

While this invention has been described in connection with what is presently considered to be exemplary embodiments, it is to be understood that the invention is not limited to the disclosed exemplary embodiments, but, on the contrary, is intended to cover various modifications and equivalent arrangements included within the spirit and scope of the accompanying claims.

What is claimed is:

1. A method for controlling a virtual engine sound for a vehicle, comprising:
detecting, by a data detector, data for determining volume of the virtual engine sound;
determining, by a controller, whether an output condition of the virtual engine sound is satisfied based on the data;
determining, by the controller, a sound source to be played back when the output condition of the virtual engine sound is satisfied;
determining, by the controller, the volume of the virtual engine sound based on a noise level extraneous to the vehicle; and
outputting, by the controller, the virtual engine sound that corresponds to the determined volume.

2. The method of claim 1, wherein the determining of the volume of the virtual engine sound comprises:
determining, by the controller, the volume of the virtual engine sound as a value greater than or equal to the noise level when the noise level is greater than or equal to a first level; and
determining, by the controller, the volume of the virtual engine sound as a value equivalent to the first level when the noise level is less than the first level.

3. The method of claim 2, wherein the first level is changed based on a current position of the vehicle.

4. The method of claim 1, wherein the output condition of the virtual engine sound is satisfied when the vehicle travels.

5. The method of claim 1, wherein the sound source to be played back is determined from among a plurality of sound sources based on a current position of the vehicle.

6. The method of claim 5, wherein the plurality of sound sources are updated through a telematics device by wire or wirelessly.

7. The method of claim 2, wherein the determining the volume of the virtual engine sound further comprises:
adjusting, by the controller, the determined volume of the virtual engine sound based on at least one of a vehicle speed and an inter-vehicle distance.

8. The method of claim 1, further comprising:
determining, by the controller, whether an output termination condition of the virtual engine sound is satisfied; and
terminating, by the controller, output of the virtual engine sound when the output termination condition of the virtual engine sound is satisfied,
wherein the output termination condition is satisfied when the vehicle is stopped.

9. The method of claim 8, wherein for a vehicle that includes an engine, the output termination condition is satisfied when the engine is operated.

10. The method of claim 1, wherein the data detector includes a vehicle speed sensor, a gear stage sensor, an inter-vehicle distance sensor, a navigation device and a microphone.

11. A virtual engine sound system outputting a virtual engine sound to the exterior of a vehicle via a speaker, comprising
a data detector configured to detect data for determining the volume of the virtual engine sound, and
a controller having a memory and a processor and configured to:
detect the data for determining the volume of the virtual engine sound from the data detected by the data detector;
determine whether an output condition of the virtual engine sound is satisfied based on the data;
determine a sound source to be played back when the output condition of the virtual engine sound is satisfied;
determine the volume of the virtual engine sound based on a noise level extraneous to the vehicle; and
output the virtual engine sound that corresponds to the determined volume.

12. The system of claim 11, wherein the data detector includes a vehicle speed sensor, a gear stage sensor, an inter-vehicle distance sensor, a navigation device and a microphone.

13. The system of claim 11, wherein the controller is further configured to:
determine the volume of the virtual engine sound as a value greater than or equal to the noise level when the noise level is greater than or equal to a first level; and
determine the volume of the virtual engine sound as a value equivalent to the first level when the noise level is less than the first level.

14. The system of claim 13, wherein the first level is changed based on a current position of the vehicle.

15. The system of claim 11, wherein the output condition of the virtual engine sound is satisfied when the vehicle travels.

16. The system of claim 11, wherein the sound source to be played back is determined from among a plurality of sound sources based on a current position of the vehicle.

17. A non-transitory computer readable medium containing program instructions executed by a controller, the computer readable medium comprising:
program instructions that detect the data for determining the volume of the virtual engine sound from the data detected by the data detector;
program instructions that determine whether an output condition of the virtual engine sound is satisfied based on the data;
program instructions that determine a sound source to be played back when the output condition of the virtual engine sound is satisfied;
program instructions that determine the volume of the virtual engine sound based on a noise level extraneous to the vehicle; and
program instructions that output the virtual engine sound that corresponds to the determined volume.

18. The non-transitory computer readable medium of claim 17, further comprising:
program instructions that determine the volume of the virtual engine sound as a value greater than or equal to the noise level when the noise level is greater than or equal to a first level; and
program instructions that determine the volume of the virtual engine sound as a value equivalent to the first level when the noise level is less than the first level.

19. The non-transitory computer readable medium of claim 18, wherein the first level is changed based on a current position of the vehicle.

20. The non-transitory computer readable medium of claim 17, wherein the output condition of the virtual engine sound is satisfied when the vehicle travels.
